(19) United States
(12) Patent Application Publication
(10) Pub. No.: US 2026/0133788 A1
(43) Pub. Date: May 14, 2026

(54) METHOD AND DEVICE FOR CONTROLLING OTA UPDATES

(71) Applicants: HYUNDAI MOTOR COMPANY, Seoul (KR); KIA CORPORATION, Seoul (KR)

(72) Inventor: Keyng Bin Im, Hwaseong-si (KR)

(73) Assignees: HYUNDAI MOTOR COMPANY, Seoul (KR); KIA CORPORATION, Seoul (KR)

(21) Appl. No.: 19/057,112

(22) Filed: Feb. 19, 2025

(30) Foreign Application Priority Data
Nov. 12, 2024 (KR) 10-2024-0159813

(51) Int. Cl. G06F 8/65

(52) U.S. Cl. CPC G06F 8/65

(57) ABSTRACT

A method for controlling OTA (Over The Air) includes analyzing destination information including at least one of a route from a current location of a vehicle to a destination, whether an indoor parking lot exists around the destination, or an estimated driving time. The method also includes detecting battery information including at least one of an installation location, current, voltage, charge level, or current temperature of a battery. The method additionally includes determining a compensation factor when an indoor parking lot exists around the destination. The method further includes determining a compensation temperature for the battery using the compensation factor. The method also includes determining whether to execute an OTA update based on the temperature of the battery.

### CROSS-REFERENCE TO RELATED APPLICATIONS

This application claims the benefit of and priority to Korea Patent Application No. 10-2024-0159813, filed on Nov. 12, 2024, the entire contents of which are hereby incorporated herein by reference.

### TECHNICAL FIELD

The present disclosure relates to a method and device for controlling OTA (Over The Air) updates.

### BACKGROUND

The content described in this Background section merely provides background information related to the present disclosure and does not necessarily constitute prior art.

In conventional vehicle control systems, when the battery temperature is below a certain temperature, OTA updates are controlled to halt to ensure the vehicle's ability to start. Therefore, there are many cases where OTA updates become infeasible due to low temperature conditions in winter.

Since the battery temperature does not change rapidly due to its high specific heat, even if the vehicle's final destination is an indoor location with a higher temperature than the outside, it is not reflected and the battery remains in a low temperature state, making OTA updates infeasible.

### SUMMARY

In view of the above, the present disclosure provides a method and device for performing OTA updates by compensating for battery temperature even at low temperatures when indoor parking is available.

The objectives to be achieved by the present disclosure are not limited to those mentioned above. Other objectives not mentioned herein should be clearly understood by those having ordinary skill in the art from the description below.

According to an aspect of the present disclosure, a method for controlling OTA (Over The Air) updates is provided. The method includes analyzing destination information including at least one of a route from a current location of a vehicle to a destination, whether an indoor parking lot exists around the destination, or an estimated driving time. The method also includes detecting battery information including at least one of an installation location, current, voltage, charge level, or current temperature of a battery. The method additionally includes determining a compensation factor when an indoor parking lot exists around the destination. The method further includes determining a compensation temperature for the battery using the compensation factor. The method also includes determining whether to execute an OTA (Over The Air) update based on the temperature of the battery.

According to another aspect of the present disclosure, a device for controlling OTA (Over The Air) updates is provided. The device includes at least one memory storing instructions and at least one processor. The at least one processor is configured to execute the instructions to: analyze destination information including at least one of a route from a current location of a vehicle to a destination, whether an indoor parking lot exists around the destination, or an estimated driving time; detect battery information including at least one of an installation location, current, voltage, charge level, or current temperature of a battery; determine a compensation factor when an indoor parking lot exists around the destination; determine a compensation temperature for the battery using the compensation factor; and determine whether to execute an OTA update based on the temperature of the battery.

According to one embodiment of the present disclosure, when indoor parking is available, OTA updates are feasible by compensating for the battery temperature even at low temperatures.

The effects of the present disclosure are not limited to those mentioned above. Other effects not mentioned herein should be more clearly understood by those having ordinary skill in the art from the description below.

### BRIEF DESCRIPTION OF THE DRAWINGS

FIG. 1 is a block diagram schematically illustrating an update control device according to one embodiment of the present disclosure.

FIG. 2 is a diagram for explaining an operating process of the update control device according to one embodiment of the present disclosure.

FIG. 3 is a flowchart illustrating an update control method according to one embodiment of the present disclosure.

FIG. 4 is a block diagram schematically illustrating an example computing device that can be used to implement the update control method according to embodiments of the present disclosure.

### DETAILED DESCRIPTION

Hereinafter, embodiments of the present disclosure are described in detail with reference to the accompanying drawings. In the accompanying drawings, like reference numerals designate like elements even when the elements are shown in different drawings. Further, in the following description, a detailed description of known functions and configurations incorporated therein has been omitted for the purpose of clarity and for brevity.

Additionally, various terms such as first, second, A, B, (a), (b), etc., are used solely to differentiate one component from another component, but not to imply or suggest the substances, order, or sequence of the components. Throughout this specification, when it is described that a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

When a component, device, element, or the like of the present disclosure is described as having a purpose or performing an operation, function, or the like, the component, device, or element should be considered herein as being “configured to” meet that purpose or perform that operation or function.

The following detailed description, together with the accompanying drawings, is intended to illustrate embodiments of the present disclosure and is not intended to represent the only embodiments in which the present disclosure may be practiced.

In the present specification, ‘low temperature’ refers to a temperature equal to or less than a threshold at which OTA updates are infeasible.

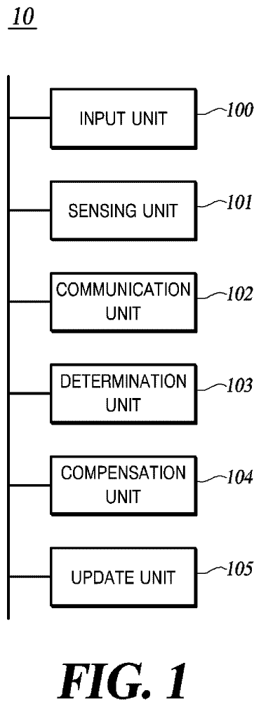

FIG. 1 is a block diagram schematically illustrating an update control device according to one embodiment of the present disclosure.

As shown in FIG. 1, an update control device 10 according to one embodiment of the present disclosure may include all or some of an input unit 100, a sensing unit 101, a communication unit 102, a determination unit 103, a compensation unit 104, and an update unit 105. Not all blocks illustrated in FIG. 1 are necessarily essential components, and in other embodiments, some blocks included in the update control device 10 may be modified or omitted and/or other blocks may be added. The components illustrated in FIG. 1 represent functionally distinct elements. At least one of the components may be implemented in an integrated form in an actual physical environment.

The input unit 100 may receive a destination of a vehicle from a user through an input device. The input device may include a keyboard, a keypad, a touchpad, a mouse, or the like, and may be any one of a graphic user interface that can be controlled using a keyboard, a keypad, a touchpad, a mouse, or the like. However, the present disclosure is not limited thereto.

The input unit 100 may receive the destination of the vehicle from the user and may provide infotainment functions including AVNT (audio, video, navigation, telecommunication).

The sensing unit 101 may detect battery information. The battery information may include at least one of the installation location, current, voltage, charge level, or current temperature of a battery. Further, the installation location of the battery includes the engine room, trunk room, and interior of the vehicle.

The communication unit 102 may be a hardware device implemented with various electronic circuits to transmit and receive signals through wireless or wired connections. The communication unit 102 may transmit and receive information to and from each component of the in-vehicle device and the update control device 10 based on in-vehicle network communication technology. As an example, the in-vehicle network communication technology may include CAN (Controller Area Network) communication, LIN (Local Interconnect Network) communication, Flex-Ray communication, etc.

In addition, the communication unit 102 may perform communication with external servers, infrastructure, other vehicles, etc. outside the vehicle through wireless Internet technology or short range communication technology. The wireless Internet technology may include WLAN (Wireless LAN), Wibro (Wireless Broadband), Wi-Fi, WiMAX (World Interoperability for Microwave Access), etc. The short range communication technology may include Bluetooth, ZigBee, UWB (Ultra Wideband), RFID (Radio Frequency Identification), IrDA (Infrared Data Association), etc. For example, the communication unit 102 may perform wireless communication with the server to update in-vehicle controllers, and can download OTA (Over The Air) update software from the server in an ignition-on state.

The determination unit 103 may analyze destination information of the vehicle. The destination information may include at least one of a route from the current location of the vehicle to the destination, whether an indoor parking lot exists around the destination, or an estimated driving time.

The determination unit 103 may determine whether a current temperature of the battery is equal to or less than a threshold. When the current temperature of the battery is below a recommended temperature for OTA updates, the determination unit 103 may determine that the current temperature of the battery is equal to or less than the threshold. The determination unit 103 may determine whether a compensation temperature for the battery is equal to or less than the threshold. When the compensation temperature for the battery is below the recommended temperature for OTA updates, the determination unit 103 may determine that the compensation temperature for the battery is equal to or less than the threshold.

The compensation unit 104 may compensate for the battery temperature according to a battery temperature compensation logic when there is an indoor parking lot around the vehicle's destination.

The compensation unit 104 may compensate for the battery temperature by determining a compensation factor for the battery temperature. The compensation unit 104 may determine the compensation factor for the battery temperature based on the installation location of the battery.

The compensation unit 104 may determine the compensation factor based on a temperature rise by engine heat when the battery is installed in the engine room of an internal combustion engine vehicle. For example, the compensation unit 104 may determine the compensation factor as 1.5 when the battery is installed in the engine room of the internal combustion engine vehicle. Further, the compensation unit 104 may determine the compensation factor based on a temperature rise by the muffler when the battery is installed in the trunk room of the internal combustion engine vehicle. For example, the compensation unit 104 may determine the compensation factor as 1.2 when the battery is installed in the trunk room of the internal combustion engine vehicle. In addition, the compensation unit 104 may determine the compensation factor based on the interior temperature when the battery is installed in the interior of the internal combustion engine vehicle. For example, the compensation unit 104 may determine the compensation factor as 1.1 when the battery is installed in the interior of the internal combustion engine vehicle.

When the battery is installed in the engine room of an EV (electric vehicle), the compensation unit 104 may determine the compensation factor based on the temperature change by air flow when the vehicle is turned off. For example, the compensation unit 104 may determine the compensation factor as 0.9 when the battery is installed in the engine room of the EV Further, when the battery is installed in the trunk room of the EV, the compensation unit 104 may determine the compensation factor based on the temperature change by the absence of air flow when the vehicle is turned off. For example, the compensation unit 104 may determine the compensation factor as 0.8 when the battery is installed in the trunk room of the EV In addition, when the battery is installed in the interior of the EV, the compensation unit 104 may determine the compensation factor based on the temperature change due to the battery being installed in the same package as a high-voltage battery. For example, the compensation unit 104 may determine the compensation factor as 0.7 when the battery is installed in the interior of the EV.

The compensation unit 104 may determine the compensation temperature for the battery using the battery compensation factor. The compensation unit 104 may calculate the compensation temperature for the battery by adding a value obtained by multiplying the compensation factor by the estimated driving time to the current temperature of the battery (compensation temperature for battery=current temperature of battery+compensation factor×estimated driving time).

The compensation unit 104 may not perform battery temperature compensation if there is no indoor parking lot around the vehicle's destination.

The update unit 105 may execute an OTA update based on the temperature of the battery. The update unit 105 may execute the OTA update if the current temperature of the battery exceeds the threshold. The update unit 105 may execute the OTA update if the compensation temperature for the battery exceeds the threshold.

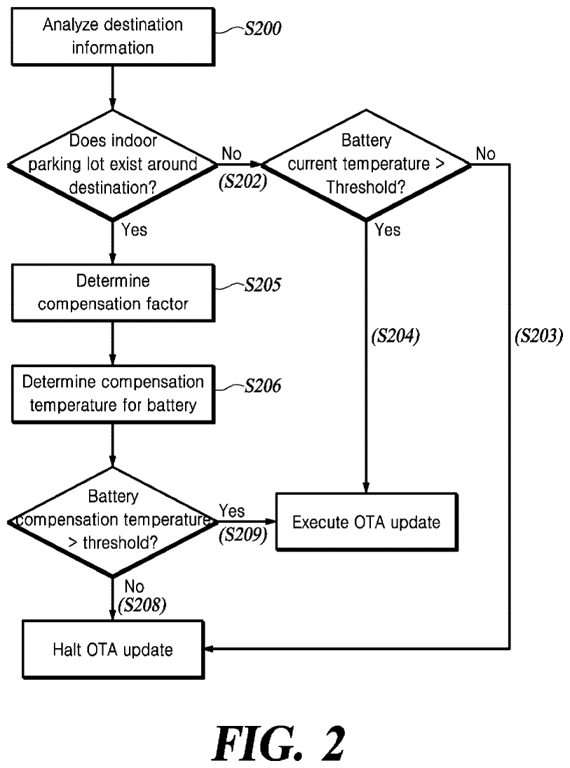

FIG. 2 is a drawing for explaining the operating process of the update control device 10 according to one embodiment of the present disclosure.

The update control device 10 may determine whether to execute an OTA update based on the temperature of the battery by downloading OTA update software from an external server and.

In an operation S200, the update control device 10 may receive a destination of the vehicle from a user and analyzes destination information. The destination information may include at least one of a route from the current location of the vehicle to the destination, whether an indoor parking lot exists around the destination, or an estimated driving time.

The update control device 10 may detect battery information. The battery information may include at least one of the installation location, current, voltage, charge level, or current temperature of the battery. The battery installation location may include the engine room, trunk room, and interior of a vehicle.

When it is determined in an operation S202 that no indoor parking lot exists around the destination, the update control device 10 may determine whether the current temperature of the battery exceeds the threshold.

The update control device 10 may halt the OTA update when it is determined in an operation S203 that the current temperature of the battery is equal to or less than the threshold. In an operation S204, the update control device 10 may execute the OTA update when the current temperature of the battery exceeds the threshold.

When it is determined that an indoor parking lot exists around the destination, the update control device 10 may determine a compensation factor in an operation S205. The update control device 10 may determine the compensation factor based on the installation location of the battery.

The update control device 10 may determine the compensation factor based on a temperature rise of the battery by engine heat when the battery is installed in the engine room of the internal combustion engine vehicle. Further, the update control device 10 may determine the compensation factor based on a temperature rise of the battery by the muffler when the battery is installed in the trunk room of the internal combustion engine vehicle. In addition, the update control device 10 may determine the compensation factor based on the interior temperature when the battery is installed in the interior of the internal combustion engine vehicle.

When the battery is installed in the engine room of an EV, the update control device 10 may determine the compensation factor based on a temperature change of the battery by air flow when the vehicle is turned off. Further, if the battery is installed in the trunk room of the EV, the update control device 10 may determine the compensation factor based on a temperature change of the battery by the absence of air flow when the vehicle is turned off. In addition, if the battery is installed in the interior of the EV, the update control device 10 may determine the compensation factor based on a temperature change of the battery due to the battery being installed in the same package as the high-voltage battery.

In an operation S206, the update control device 10 may determine the compensation temperature for the battery by using the battery compensation factor. The update control device 10 may calculate the compensation temperature for the battery by using the equation of ‘compensation temperature for battery=current temperature of battery+compensation factor×estimated driving time’.

In an operation S208, the update control device 10 halts the OTA update when the battery's compensation temperature is equal to or less than the threshold. In an operation S209, the update control device 10 executes the OTA update when the battery's compensation temperature exceeds the threshold.

The update control device 10 may perform OTA updates even at low temperatures in winter through the battery temperature compensation logic.

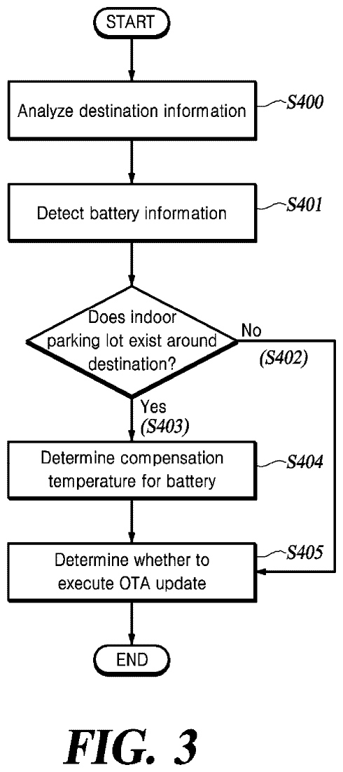

FIG. 3 is a flowchart illustrating an update control method according to one embodiment of the present disclosure. The method illustrated in FIG. 3 may be implemented by being executed by an update control system comprising one or more physical devices including the update control device 10 of FIG. 1. The following description is given in terms of operations performed by the update control system.

The update control system may download OTA update software from an external server. The update control system may halt OTA updates when the battery temperature is equal to or less than a threshold. The update control system may execute the OTA updates when the battery temperature exceeds the threshold.

The update control system may determine whether an indoor parking lot exists using the destination information analysis results.

In an operation S400, the update control system receives a destination of a vehicle from a user and analyzes the destination information. The destination information may include at least one of a route from the current location of the vehicle to the destination, whether an indoor parking lot exists around the destination, or an estimated driving time.

In an operation S401, the update control system detects battery information. The battery information may include at least one of the installation location of the battery, and current, voltage, charge level, or current temperature of a battery. The installation location of the battery may include the engine room, trunk room, and interior of the vehicle.

In an operation S402, the update control system may determine whether to execute the OTA updates based on the current temperature of the battery. The update control system halts the OTA updates when the current temperature of the battery is equal to or less than the threshold. The update control system executes the OTA updates when the current temperature of the battery exceeds the threshold.

In an operation S403, the update control system operates battery temperature compensation logic when an indoor parking lot exists around the destination. The update control system determines a compensation factor based on the installation location of the battery. For example, the update control system may determine the compensation factor based on a temperature rise by engine heat when the battery is installed in the engine room of an internal combustion engine vehicle. Further, the update control system may determine the compensation factor based on a temperature rise by the muffler when the battery is installed in the trunk room of the internal combustion engine vehicle. In addition, the update control system may determine the compensation factor based on the interior temperature when the battery is installed in the interior of the internal combustion engine vehicle. Furthermore, the update control system may determine the compensation factor based on the temperature change by air flow when the vehicle is turned off when the battery is installed in the engine room of an EV. Further, the update control system may determine the compensation factor based on the temperature change by the absence of air flow when the vehicle is turned off when the battery is installed in the trunk room of the EV. In addition, the update control system may determine the compensation factor based on the temperature change due to the battery being installed in the same package as the high-voltage battery when the battery is installed in the interior of the EV.

In an operation S404, the update control system may determine the compensation temperature for the battery by using the battery compensation factor. The update control system may calculate the compensation temperature for the battery by using the equation of ‘compensation temperature for battery=current temperature of battery+compensation factor×estimated driving time’.

In an operation S405, the update control system may determine whether to execute the OTA update based on the compensation temperature for the battery. The update control system may halt the OTA update when the compensation temperature for the battery is equal to or less than the threshold. The update control system may execute the OTA update when the compensation temperature for the battery exceeds the threshold.

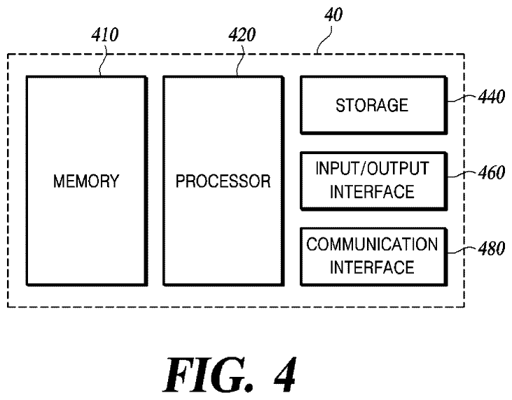

FIG. 4 is a block diagram schematically illustrating an example computing device 40 that can be used to implement the update control method according to the present disclosure.

The computing device 40 may include some or all of a memory 410, a processor 420, a storage 440, an input/output interface 460, and a communication interface 480. The computing device 40 may structurally and/or functionally include at least a portion of the update control device 10. The computing device 40 may be a stationary computing device such as a desktop computer, a server, an AI accelerator, or the like, as well as a portable computing device such as a laptop computer, a smart phone, or the like.

The memory 410 may store a program that enables the processor 420 to perform methods or operations according to various embodiments of the present disclosure. For example, the program may include a plurality of instructions executable by the processor 420, and the above-described method can be performed by executing the plurality of instructions by the processor 420.

The memory 410 may be provided as a single memory or a plurality of memories. In this case, information required to perform the methods or operations according to various embodiments of the present disclosure may be stored in the single memory or divided and stored in the plurality of memories. When the memory 410 is comprised of the plurality of memories, the plurality of memories may be physically separated.

The memory 410 may include at least one of volatile memory and non-volatile memory. The volatile memory includes SRAM (Static Random Access Memory) or DRAM (Dynamic Random Access Memory), for example, and the non-volatile memory includes flash memory, for example.

The processor 420 may include at least one core capable of executing at least one instruction. The processor 420 may execute instructions stored in the memory 410. The processor 420 may be provided as a single processor or a plurality of processors.

The storage 440 maintains stored data even when power supplied to the computing device 40 is cut off. For example, the storage 440 may include non-volatile memory, and may include a storage medium such as a magnetic tape, an optical disk, or a magnetic disk.

The program stored in the storage 440 may be loaded into the memory 410 before being executed by the processor 420. The storage 440 may store a file written in a programming language, and a program generated from the file by a compiler or the like may be loaded into the memory 410. The storage 440 may store data to be processed by the processor 420 and/or data processed by the processor 420.

The input/output interface 460 may include an input device such as a keyboard, a mouse, or the like, and may include an output device such as a display device, a printer, or the like. The user may trigger the execution of a program by the processor 420 and/or check the processing result of the processor 420 through the input/output interface.

The communication interface 480 may provide access to an external network. For example, the computing device 40 may communicate with other devices through the communication interface 480.

Each element of the apparatus or method can be implemented in hardware or software, or a combination of hardware and software. The functions of the respective elements may be implemented in software, and a microprocessor can be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various implementations can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

A computer-readable recording medium includes any type of recording device that stores data that can be read by a computer system. Such a computer-readable recording medium may be a non-volatile or non-transitory medium, such as a ROM, CD-ROM, magnetic tape, floppy disk, memory card, hard disk, optical magnetic disk, or storage device, and may further include a transitory medium, such as a data transmission medium. The computer-readable recording medium may also be distributed across a networked computer system, such that the computer-readable code is stored and executed in a distributed manner.

Although operations are illustrated in the flowcharts/timing charts in this specification as being sequentially performed, this is merely an illustrative description of the technical idea of one embodiment of the present disclosure. In other words, those having ordinary skill in the art to which the present disclosure pertains should appreciate that various modifications and changes can be made without departing from essential features of embodiments of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the claimed present disclosure. Therefore, the embodiments of the present disclosure have been described for the sake of brevity and clarity. The scope of the technical idea of the present disclosure is not limited by the illustrations. Accordingly, one of ordinary skill in the art would understand that the scope of the claimed present disclosure is not to be limited by the above explicitly described embodiments but by the claims and equivalents thereof.

What is claimed is:

1. A method comprising:
analyzing destination information including at least one of a route from a current location of a vehicle to a destination, whether an indoor parking lot exists around the destination, or an estimated driving time;
detecting battery information including at least one of an installation location, current, voltage, charge level, or current temperature of a battery;
determining a compensation factor when an indoor parking lot exists around the destination;
determining a compensation temperature for the battery using the compensation factor; and
determining whether to execute an Over The Air (OTA) update based on the temperature of the battery.

2. The method of claim 1, wherein determining the compensation factor includes determining the compensation factor based on the installation location of the battery.

3. The method of claim 2, wherein when the battery is installed in an engine room of an internal combustion engine vehicle, determining the compensation factor includes determining the compensation factor based on a temperature rise of the battery by engine heat.

4. The method of claim 2, wherein when the battery is installed in a trunk room of an internal combustion engine vehicle, determining the compensation factor includes determining the compensation factor based on a temperature rise of the battery due to a muffler.

5. The method of claim 2, wherein when the battery is installed in an interior of an internal combustion engine vehicle, determining the compensation factor includes determining the compensation factor based on a temperature of the interior.

6. The method of claim 2, wherein when the battery is installed in an engine room of an electric vehicle (EV), determining the compensation factor includes determining the compensation factor based on a temperature change of the battery by air flow when the vehicle is turned off.

7. The method of claim 2, wherein when the battery is installed in a trunk room of an electric vehicle (EV), determining the compensation factor includes determining the compensation factor based on a temperature change of the battery by the absence of air flow when the vehicle is turned off.

8. The method of claim 2, wherein when the battery is installed in an interior of an electric vehicle (EV), determining the compensation factor includes determining the compensation factor based on a temperature change of the battery due to the battery being installed in a same package as a high-voltage battery.

9. The method of claim 2, wherein determining the compensation temperature for the battery includes calculating the compensation temperature for the battery by adding a value obtained by multiplying the compensation factor and the estimated driving time to the current temperature of the battery.

10. The method of claim 2, wherein determining whether to execute the OTA update includes halting the OTA update when the compensation temperature for the battery is equal to or less than a threshold.

11. The method of claim 10, wherein determining whether to execute the OTA update includes executing the OTA update when the compensation temperature for the battery exceeds the threshold.

12. A device comprising:
at least one memory storing instructions; and
at least one processor,
wherein the at least one processor is configured to execute the instructions to:
analyze destination information including at least one of a route from a current location of a vehicle to a destination, whether an indoor parking lot exists around the destination, or an estimated driving time;
detect battery information including at least one of an installation location, current, voltage, charge level, or current temperature of a battery;
determine a compensation factor when an indoor parking lot exists around the destination;
determine a compensation temperature for the battery using the compensation factor; and
determine whether to execute an Over The Air (OTA) update based on the temperature of the battery.

13. The device of claim 12, wherein the at least one processor is configured to determine the compensation factor based on the installation location of the battery.

14. The device of claim 13, wherein when the battery is installed in an engine room of an internal combustion engine vehicle, the at least one processor is configured to determine the compensation factor based on a temperature rise of the battery by engine heat.

15. The device of claim 13, wherein when the battery is installed in a trunk room of an internal combustion engine vehicle, the at least one processor is configured to determine the compensation factor based on a temperature rise of the battery by a muffler.

16. The device of claim 13, wherein when the battery is installed in an interior of an internal combustion engine vehicle, the at least one processor is configured to determine the compensation factor based on a temperature of the interior.

17. The device of claim 13, wherein when the battery is installed in an engine room of an electric vehicle (EV), the at least one processor is configured to determine the compensation factor based on a temperature change of the battery by air flow when the vehicle is turned off.

18. The device of claim 13, wherein when the battery is installed in a trunk room of an electric vehicle (EV), the at least one processor is configured to determine the compensation factor based on a temperature change of the battery by the absence of air flow when the vehicle is turned off.

19. The device of claim 13, wherein when the battery is installed in an interior of an electric vehicle (EV), the at least one processor is configured to determine the compensation factor based on a temperature change of the battery due to the battery being installed in a same package as a high-voltage battery.

20. The device of claim 13, wherein the at least one processor is configured to calculate the compensation temperature for the battery by adding a value obtained by multiplying the compensation factor and the estimated driving time to the current temperature of the battery.
